(19) United States
(12) Patent Application Publication
(10) Pub. No.: US 2023/0127214 A1
(43) Pub. Date: Apr. 27, 2023

(54) TOUCH DISPLAY DEVICE AND CONTROL METHOD THEREOF

(71) Applicant: Ta-Wei Liu, Hsinchu City (TW)

(72) Inventor: Ta-Wei Liu, Hsinchu City (TW)

(73) Assignee: ITE Tech. Inc., Hsinchu (TW)

(21) Appl. No.: 17/585,560

(22) Filed: Jan. 27, 2022

(30) Foreign Application Priority Data
Oct. 26, 2021 (TW) 110139662

(51) Int. Cl. G06F 3/041

(52) U.S. Cl. CPC G06F 3/04184; G06F 3/04166

(57) ABSTRACT

A touch display device and a control method thereof are provided. The control method includes: setting a display scan sequence and a touch detection scan sequence; performing a display scan operation according to the display scan sequence based on a first frequency according to a control signal; and performing a touch scan operation according to the touch detection scan sequence based on a second frequency according to the control signal. At a same time point, a scanned display area corresponding to the display scan operation and a scanned touch area corresponding to the touch scan operation are non-overlapped.

### CROSS-REFERENCE TO RELATED APPLICATION

This application claims the priority benefit of Taiwanese application no. 110139662, filed on Oct. 26, 2021. The entirety of the above-mentioned patent application is hereby incorporated by reference herein and made a part of this specification.

### BACKGROUND

### Technical Field

The disclosure relates to a touch display device and a control method thereof, and particularly relates to a touch display device and a control method thereof that can reduce interference.

### Description of Related Art

The distance between touch control and display panel is getting closer with the change of the market's demand for lighter, thinner, and smaller products as the size of glass becomes thinner. Especially for embedded products, the interference caused by display operations to touch detection operations becomes more obvious.

In the conventional technical field, a single-frequency hopping scan method or a multi-frequency scan method is adopted to reduce the interference between touch detection operation and display scan operation. These methods often require a relatively complex architecture. In the conventional technical field, touch detection and display scan methods may also be performed through time division. With the increasing demand for large panel size, it is also difficult to implement time division arrangement.

### SUMMARY

The disclosure provides a variety of touch display devices and control methods thereof, which can reduce possible interference generated between touch scan operations and display scan operations.

The control method of the disclosure includes: setting a display scan sequence and a touch detection scan sequence; performing a display scan operation according to the display scan sequence based on a first frequency according to a control signal; and, performing a touch scan operation according to the touch detection scan sequence based on the second frequency according to the control signal. At a same time point, a scanned display area corresponding to the display scan operation and a scanned touch area corresponding to the touch scan operation are non-overlapped.

A touch display device of the disclosure includes a touch display panel and a controller. The controller is coupled to the touch control display panel to: set the display scan sequence and the touch detection scan sequence; perform the display scan operation according to the display scan sequence based on the first frequency according to the control signal; perform the touch scan operation according to the touch detection scan sequence based on the second frequency according to the control signal. At a same time point, a scanned display area corresponding to the display scan operation and a scanned touch area corresponding to the touch scan operation are non-overlapped.

Another touch display device of the disclosure includes a touch display panel and a controller. The controller is coupled to the touch control display panel for: receiving the display scan sequence to set the touch detection scan sequence; performing the display scan operation according to the display scan sequence based on the first frequency according to the control signal; and, performing the touch scan operation according to the touch detection scan sequence based on the second frequency according to the control signal. At a same time point, a scanned display area corresponding to the display scan operation and a scanned touch area corresponding to the touch scan operation are non-overlapped.

Based on the above, the disclosure performs the display scan operation according to the display scan sequence based on the first frequency according to the display scan sequence and the touch detection scan sequence, and performs the touch scan operation according to the touch detection scan sequence based on the second frequency. In the embodiment of the disclosure, at a same time point, by making a scanned display area corresponding to the display scan operation and a scanned touch area corresponding to the touch scan operation not to overlap each other, it is possible to effectively reduce the possibility of interference generated between the display scan operation and the touch scan operation, and the performance of the touch display device can be improved.

### BRIEF DESCRIPTION OF THE DRAWINGS

FIG. 1 is a flowchart of a control method of a touch display device according to an embodiment of the disclosure.

FIG. 2 is a schematic view showing a scan operation of the touch display device according to an embodiment of the disclosure.

FIG. 3A is a schematic view showing a waveform of a scan operation of the touch display device according to an embodiment of the disclosure.

FIG. 3B is a schematic view showing a waveform of another scan operation of the touch display device according to an embodiment of the disclosure.

FIG. 4A and FIG. 4B are schematic views of a layout of a display row and a touch area according to another embodiment of the disclosure.

FIG. 5 is a schematic view showing a waveform of a scan operation of the touch display device of the embodiments of FIG. 4A and FIG. 4B of the disclosure.

FIG. 6 is a schematic view showing a relationship between the scanned display row and the scanned touch area set by the touch display device in an embodiment of the disclosure.

FIG. 7A to FIG. 7D respectively show schematic views of implementations of various touch areas in a touch display device according to an embodiment of the disclosure.

FIG. 8 is a schematic view of a touch display device according to an embodiment of the disclosure.

FIG. 9 is a schematic view of an implementation of a controller according to an embodiment of the disclosure.

### DESCRIPTION OF THE EMBODIMENTS

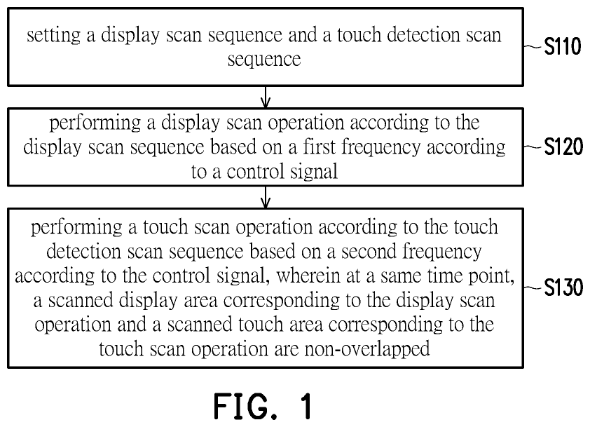

Please refer to FIG. 1. FIG. 1 is a flowchart of a control method of a touch display device according to an embodiment of the disclosure. In step S110, a display scan sequence and a touch detection scan sequence are set. Then, in steps S120 and S130, a display scan operation is performed according to the display scan sequence based on a first frequency according to a control signal, and a touch scan operation is performed according to the touch detection scan sequence based on a second frequency. In the embodiment of the disclosure, at a same time point, the scanned display area corresponding to the display scan operation and the scanned touch area corresponding to the touch scan operation are non-overlapped. Moreover, the first frequency and second frequency may be the same or different.

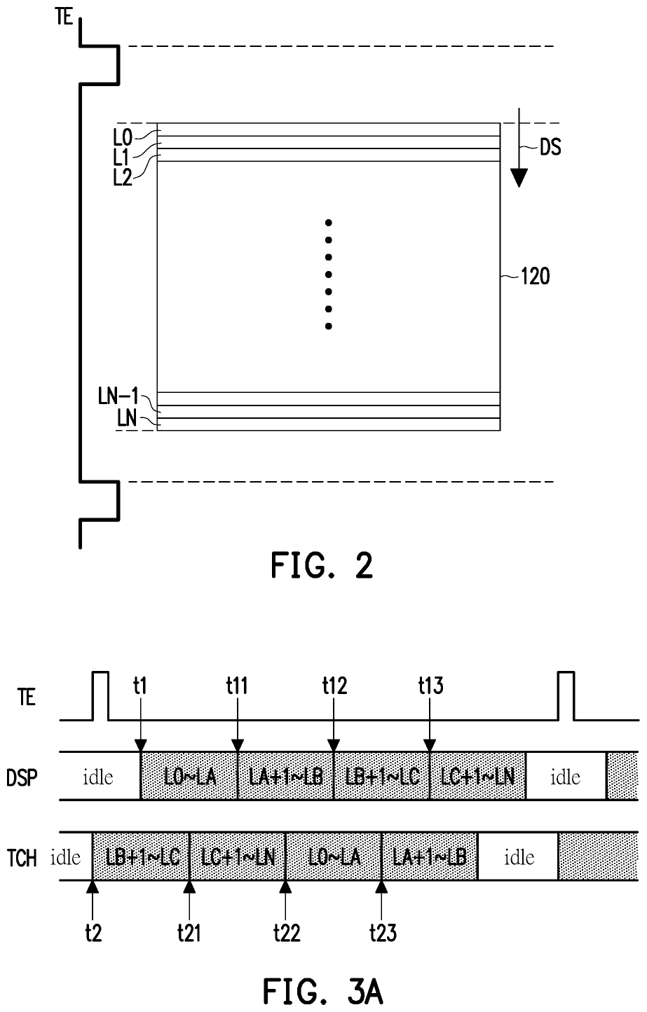

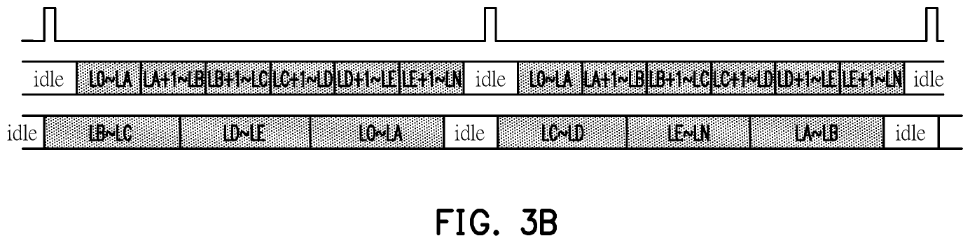

Please refer to FIG. 2 and FIG. 3A for details of operation. FIG. 2 is a schematic view showing a scan operation of the touch display device according to an embodiment of the disclosure, and FIG. 3A is a schematic view showing a waveform of a scan operation of the touch display device according to an embodiment of the disclosure. In FIG. 2, the touch display panel 210 in the touch display device can be divided into a plurality of display rows L0˜LN and divided into a plurality of touch areas. The plurality of touch areas in this embodiment are respectively overlapped with the plurality of display rows L0˜LN.

Corresponding to step S110 in FIG. 1, the touch display device can start the touch scan and display scan operations according to the control signal TE. In an embodiment, the control signal TE may be a vertical synchronization signal, and the length of time between two positive pulses of the control signal TE may be a frame period.

The touch display device can set the start time of the touch scan operation and the start time of the display scan operation according to the positive pulses of the control signal TE. For example, in FIG. 3A, the touch display device can set the display start time t1 according to the positive pulse of the control signal TE, and start the display scan operation according to the display start time t1 corresponding to step S120. The touch display device can set the touch start time point t2 according to the positive pulse of the control signal TE, and start the touch scan operation according to the touch start time point t2 corresponding to step S130.

In the embodiment of FIG. 2, the display scan direction DS can be set to scan sequentially from the upper display row L0 to the lower display row LN. In FIG. 3A, when the rising edge of the control signal TE is detected, the touch scan operation is started first at the touch start time point t2, and the scanned touch area TCH is the touch area corresponding to the display rows LB+1˜LC. Then, following a delay time after the falling edge of the control signal TE is detected, the display start time point t1 is set. The touch display device starts the display scan operation according to the display start time point t1, and makes the scanned display rows DSP as display rows L0˜LA in sequence. It should be noted that in other embodiments of the disclosure, the display scan direction can also be scanning from the lower display row to the upper display row. In fact, all display row scan methods commonly used by those skilled in the art can be applied to the disclosure, there is no limitation set to the disclosure.

At time point t21, the scanned touch area TCH is changed to the touch area corresponding to the display rows LC+1˜LN. At the subsequent time point t11, the scanned display row DSP becomes the display rows LA+1˜LB in sequence. Then, at time point t22, the scanned touch area TCH is changed to the touch area corresponding to the display rows L0˜LA. At the subsequent time point t12, the scanned display row DSP becomes the display rows LB+1˜LC in sequence. Then, at time point t23, the scanned touch area TCH is changed to the touch area corresponding to the display rows LA+1˜LB. At the subsequent time point t13, the scanned display row DSP becomes the display rows LC+1˜LN in sequence.

Based on the above description, it can be found that at any time point, the display row and the touch area that are scanned simultaneously are non-overlapped. In this way, the display scan operation and touch scan operation can be effectively separated in position, thereby reducing the possibility of interference generated between each other.

It should be noted that the touch detection scan sequence and display scan sequence can be preset. The touch display device can start the display scan operation according to the display start time point t1 according to the preset touch detection scan sequence and the display scan sequence, and start the touch scan operation according to the touch start time point t2.

In addition, in the embodiment of the disclosure, the touch display device may have one or more sets of touch detection scan sequence and display scan sequence. The touch display device can select one of multiple display scan sequences to perform the display scan operation according to the requirements of the display effect, and select the corresponding touch detection scan sequence to perform the touch scan operation. The focus lies in that, at any time point, the display row and the touch area that are scanned simultaneously are non-overlapped, so that the interference between each other can be effectively reduced, and the quality of the touch display is improved.

In the embodiment of FIG. 3A, the touch display panel 210 can be divided into four equal parts, the display row LA can be the N/4th display row; the display row LB can be the N/2th display row; and the display row LC can be the 3N/4th display row.

Incidentally, the touch display device of the embodiment of the disclosure performs the display scan operation according to a first frequency, and performs the touch scan operation according to a second frequency, and the first frequency may be equal to the second frequency. In the embodiment of the disclosure, the second frequency may be, for example, twice the first frequency, but is not limited thereto. The relationship between the second frequency and the first frequency, for example, can be set according to the relationship between the display row and the number of touch areas, and there is no fixed limitation. For example, in other embodiments of the disclosure, the second frequency may also be greater than the first frequency or less than the first frequency.

In addition, refer to FIG. 3B, FIG. 3B is a schematic view showing a waveform of another scan operation of the touch display device according to an embodiment of the disclosure. In each frame period, the scanned display row DSP is display rows L0˜LA, LA+1˜LB, LB+1˜LC, LC+1˜LD, LD+1˜LE, and LE+1˜LN in sequence. In addition, in the first frame period, the scanned touch area TCH is the touch area corresponding to the display rows LB˜LC, LD˜LE, and L0˜LA in sequence. In the second frame period, the scanned touch area TCH is the touch area corresponding to the display rows LC˜LD, LE˜LN, and LA˜LB in sequence. That is, in this embodiment, the touch area can be divided into six blocks, and the scan operation is completed once in multiple (for example, 2) frame periods. In this embodiment, the display row LA can be the N/6th display row; the display row LB can be the N/3th display row; the display row LC can be the N/2th display row; the display row LD can be the 2N/3th display row; and the display row LC can be the 5N/6th display row.

In the embodiment of the disclosure, the second frequency may be less than the first frequency.

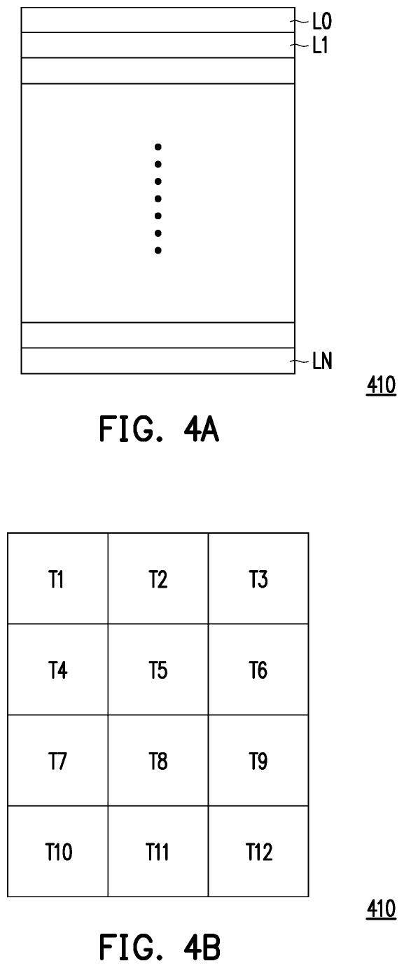

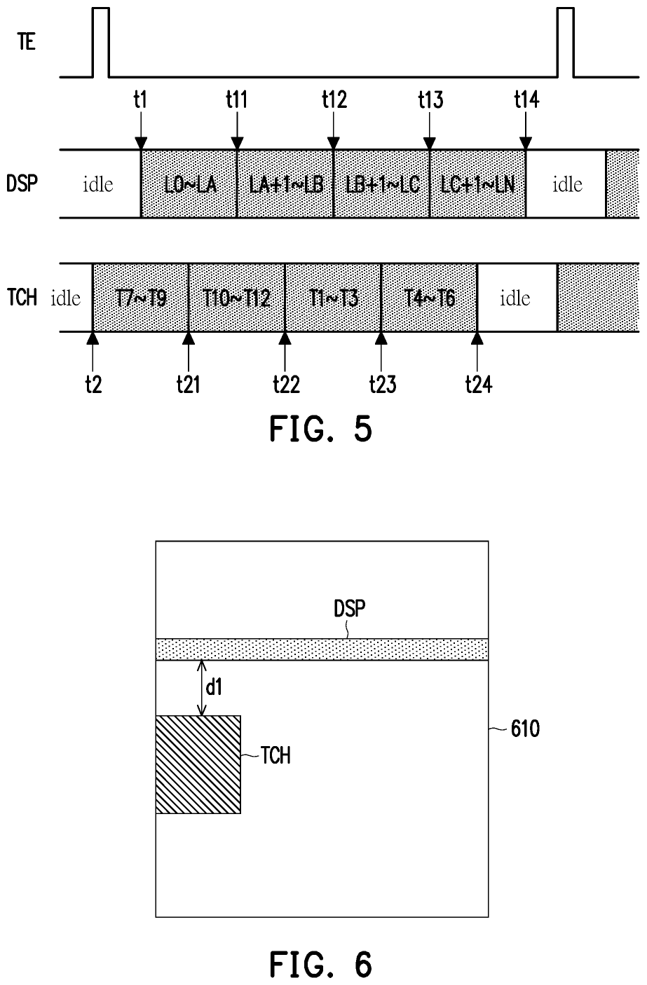

Please refer to FIG. 4A and FIG. 4B. FIG. 4A and FIG. 4B are schematic views of a layout of a display row and a touch area according to another embodiment of the disclosure. In FIG. 4A, the touch display panel 410 may have display rows L0˜LN arranged in sequence. In FIG. 4B, the touch display panel 410 may have touch areas T1˜T12 arranged in an array. For details of performing display and touch scan operation, reference may be made to FIG. 5, which illustrates a schematic view of the waveform of scan operation of the touch display device in the embodiments of FIG. 4A and FIG. 4B of the disclosure. According to the control signal TE, the touch display device can set the display start time point t1 and the touch start time point t2. The touch display device starts the display scan operation at the display start time point t1, so as to perform the display scan operation for the display rows L0˜LA in sequence between the display start time point t1 and the time point t11. Meanwhile, the touch display device can start the touch scan operation at the touch start time point t2 to perform the touch scan operation for the touch areas T7˜T9 in sequence between the touch start time point t2 and the time point t21.

Then, the touch display device performs the display scan operation for the display rows LA+1˜LB in sequence between time points t11 and t12, and performs the touch scan operation for touch areas T10˜T12 in sequence between time points t21 and t22.

The touch display device performs the display scan operation for display rows LB+1˜LC in sequence between time points t12˜t13, and performs the touch scan operation for touch areas T1˜T3 in sequence between time points t22˜t23. The touch display device performs the display scan operation for display rows LC+1˜LN in sequence between time points t13 and t14, and performs the touch scan operation for touch areas T4˜T6 in sequence between time points t23 and t24.

According to the illustration in FIG. 5, it can be obtained that during the operation of the touch display device, at any time point, the scanned display row and the touch area do not overlap with each other at all. In this manner, it is possible to effectively reduce the interference that may occur between the scanned display row and the touch area, and maintain the accuracy of touch detection and the quality of the display.

It should be noted that since the frequency of the touch scan operation performed by the touch display device is equal to the frequency of the display scan operation, each display row can be scanned once in a single frame period, and each touch control area may be scanned once or multiple times.

Please refer to FIG. 6. FIG. 6 is a schematic view showing a relationship between the scanned display row and the scanned touch area set by the touch display device in an embodiment of the disclosure. In FIG. 6, at a same time point, the touch display device of the embodiment of the disclosure can make the shortest distance dl between the scanned display row DSP and the scanned touch area TCH on the touch display panel 610 to be greater than the preset threshold. Through this setting, the mutual interference between the scanned display row DSP and the scanned touch area TCH can be further reduced, and the quality of touch detection and display can be maintained.

The threshold can be set according to the size of the touch display panel 610, the size of each display row and each touch area, and the relationship between the operating frequencies of the touch scan operation and the display scan operation.

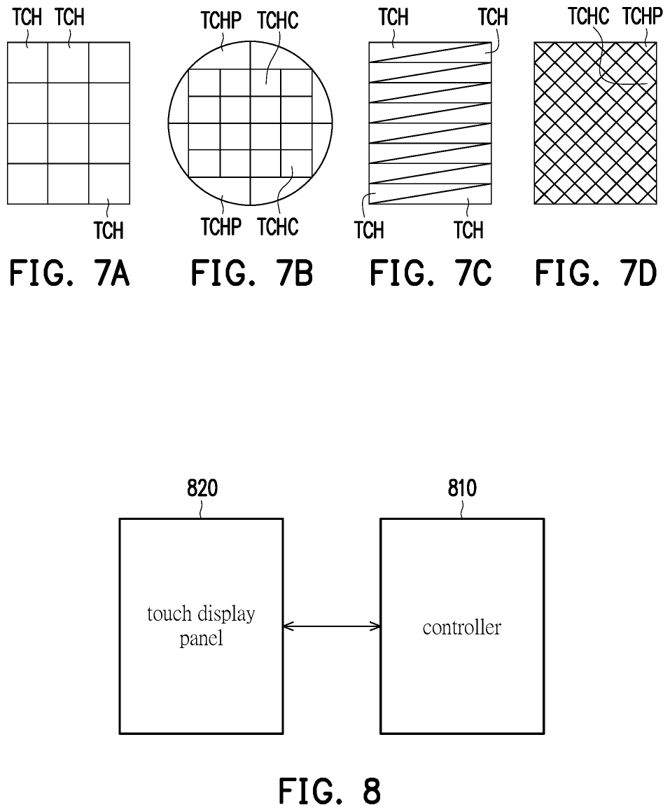

Please refer to FIG. 7A to FIG. 7D. FIG. 7A to FIG. 7D respectively show schematic views of implementations of various touch areas in a touch display device according to an embodiment of the disclosure. In FIG. 7A, each touch area TCH can be rectangular and arranged in an array. In FIG. 7B, based on the arc shape of the touch display panel, the touch area TCHC in the center region may be rectangular, and the touch area TCHP in the surrounding region may be fan-shaped. In FIG. 7C, each touch area TCH can be a triangle. In FIG. 7D, the touch area TCHC located in the middle part can all be diamond-shaped, and the touch area TCHP located in the peripheral part can be triangular.

The illustrations in FIG. 7A to FIG. 7D are only examples for description. Those with ordinary knowledge in the art can recombine and modify the examples according to the illustrations in FIG. 7A to FIG. 7D to set the touch area, the disclosure provides no limitation thereto.

Please refer to FIG. 8. FIG. 8 is a schematic view of a touch display device according to an embodiment of the disclosure. The touch display device 800 includes a controller 810 and a touch display panel 820. The touch display panel 820 may have multiple display rows and multiple touch areas. The controller 810 is adapted to perform a plurality of steps S110 to S130 of the control method as shown in FIG. 1.

The implementation details of the multiple steps S110 to S130 of the control method shown in FIG. 1 have been described in detail in the foregoing multiple embodiments and implementations, and will not be repeated here.

In this embodiment, the controller 810 can be implemented as a timing controller that is familiar to those with ordinary knowledge in the field of touch display.

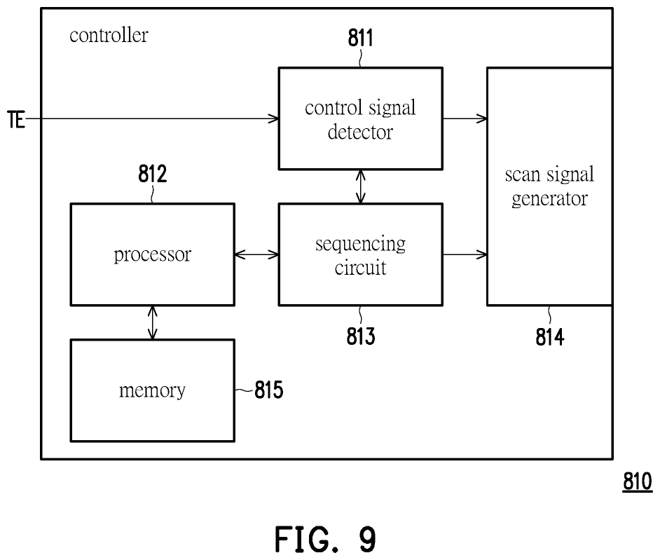

Regarding the implementation details of the controller 810, reference may be made to the schematic view of the implementation of the controller according to the embodiment of the disclosure shown in FIG. 9. The controller 810 includes a control signal detector 811, a processor 812, a sequencing circuit 813, a scan signal generator 814, and a memory 815. In an embodiment of the disclosure, the control signal detector 811 is adapted to receive the control signal TE, and to set the display start time point of the display scan operation and set the touch start time point of the touch scan operation according to the control signal TE. The processor 812 is adapted to set the display scan sequence and the touch detection scan sequence.

In another embodiment of the disclosure, the display start time point and the display scan sequence of the display scan operation can be set by another controller other than the controller 810. The control signal detector 811 receives the control signal TE, and sets the touch start time point of the touch scan operation according to the control signal TE and the display scan sequence. The processor 812 is adapted to receive the display scan sequence provided by another controller, and performs the setting operation on the touch detection scan sequence.

The sequencing circuit 813 can generate the display scan control signal and the touch scan control signal according to the display scan sequence and the touch detection scan sequence based on the display start time point and the touch start time point. The scan signal generator 814 can respectively generate a plurality of display scan signals and a plurality of touch scan signals according to the display scan control signal and the touch scan control signal.

In addition, the memory 815 can be adapted to store one or more candidate display scan sequences and one or more candidate touch detection scan sequences. Multiple candidate display scan sequences may respectively correspond to multiple candidate touch detection scan sequences to form multiple scan sequence groups. The processor 812 can select one of the multiple scan sequence groups, and set the display scan sequence and the touch detection scan sequence accordingly.

In this embodiment, the control signal detector 811, the processor 812, the sequencing circuit 813, and the scan signal generator 814 may all be constructed by digital circuits. The control signal detector 811, the processor 812, the sequencing circuit 813, and the scan signal generator 814 can be generated by using digital circuit design methods commonly known in the art, such as through Karnaugh map, truth table, or through hardware description language and circuit synthesis software, the disclosure provides no limitation thereto.

In summary, the touch display device of the disclosure makes the scanned display row and the touch area not to overlap each other at a same time point in the display scan operation and touch scan operation based on the set display scan sequence and touch detection scan sequence. In this manner, it is possible to reduce the interference that may occur between the display row and touch area, thereby maintaining the quality of display and touch detection.

1. A control method of a touch display device, comprising:
setting a display scan sequence and a touch detection scan sequence;
performing a display scan operation according to the display scan sequence based on a first frequency according to a control signal; and
performing a touch scan operation according to the touch detection scan sequence based on a second frequency according to the control signal,
wherein at a same time point, the display scan operation and the touch scan operation are performed, and a scanned display area corresponding to the display scan operation and a scanned touch area corresponding to the touch scan operation are non-overlapped.

2. The control method according to claim 1, wherein the control signal is a vertical synchronization signal.

3. The control method according to claim 1, wherein the step of performing the display scan operation according to the display scan sequence based on the first frequency according to the control signal comprises:
setting a display start time point of the display scan operation according to the control signal, and starting the display scan operation according to the display start time point.

4. The control method according to claim 3, wherein the step of performing the touch scan operation according to the touch detection scan sequence based on the second frequency according to the control signal comprises:
setting a touch start time point of the touch scan operation according to the control signal, and starting the touch scan operation according to the touch start time point,
wherein the display start time point is different from the touch start time point.

5. The control method according to claim 1, wherein the first frequency is less than, greater than or equal to the second frequency.

6. The control method according to claim 1, wherein the touch display device has a plurality of touch areas and a plurality of display rows, and the control method further comprises:
in a frame period, making each of the display rows be scanned once, making each of a plurality of first touch areas of the touch areas be scanned once, and making at least one second touch area of the touch areas be scanned multiple times.

7. The control method according to claim 6, wherein a shape of each of the touch areas is rectangle, triangle, diamond or fan.

8. The control method according to claim 6, wherein a minimum distance between the scanned touch area and the scanned display row is greater than a preset threshold.

9. A touch display device, comprising:
a touch display panel; and
a controller, coupled to the touch display panel, configured for:
setting a display scan sequence and a touch detection scan sequence;
performing a display scan operation according to the display scan sequence based on a first frequency according to a control signal;
performing a touch scan operation according to the touch detection scan sequence based on a second frequency according to the control signal,
wherein at a same time point, the display scan operation and the touch scan operation are performed, and a scanned display area corresponding to the display scan operation and a scanned touch area corresponding to the touch scan operation are non-overlapped.

10. The touch display device according to claim 9, wherein the first frequency is less than, equal to or greater than the second frequency.

11. The touch display device according to claim 9, wherein the touch display panel has a plurality of touch areas and a plurality of display rows, and the controller is further configured to:
in a frame period, make each of the display rows be scanned once, make each of a plurality of first touch areas of the touch areas be scanned once, and make at least one second touch area of the touch areas be scanned multiple times.

12. The touch display device according to claim 11, wherein a shape of each of the touch areas is rectangle, triangle, diamond or fan.

13. The touch display device according to claim 9, wherein the controller comprises:
a control signal detector, adapted to receive the control signal, and to set a display start time point of the display scan operation and set a touch start time point of the touch scan operation according to the control signal;
a processor, adapted to set a display scan sequence and a touch detection scan sequence;
a sequencing circuit, adapted to generate a display scan control signal and a touch scan control signal according to the display scan sequence and the touch detection scan sequence based on the display start time point and the touch start time point; and
a scan signal generator, adapted to respectively generate a plurality of display scan signals and a plurality of touch scan signals according to the display scan control signal and the touch scan control signal.

14. The touch display device according to claim 13, wherein the display start time point and the touch start time point are different.

15. The touch display device according to claim 13, wherein the controller further comprises:
a memory, coupled to the processor, storing at least one candidate display scan sequence and at least one candidate touch detection scan sequence.

16. A touch display device, comprising:
a touch display panel; and
a controller, coupled to the touch display panel, configured for:
receiving a display scan sequence, and setting a touch detection scan sequence;
performing a display scan operation according to the display scan sequence based on a first frequency according to a control signal;
performing a touch scan operation according to the touch detection scan sequence based on a second frequency according to the control signal,
wherein at a same time point, the display scan operation and the touch scan operation are performed, and a scanned display area corresponding to the display scan operation and a scanned touch area corresponding to the touch scan operation are non-overlapped.
